(19) United States
(12) Patent Application Publication
(10) Pub. No.: US 2011/0153741 A1
(43) Pub. Date: Jun. 23, 2011

(54) System and Method for Cost Effectively Distributing Electronic Content

(75) Inventors: Vincent Le Chevalier, San Jose, CA (US); Serge Rutman, Boulder Creek, CA (US)

(73) Assignee: SKIFF, LLC, NEW YORK, NY (US)

(21) Appl. No.: 12/644,538

(22) Filed: Dec. 22, 2009

(51) Int. Cl. G06F 15/16; G06Q 10/00; G06Q 50/00

(52) U.S. Cl. 709/204; 705/301; 709/226

(57) ABSTRACT

A system and method for cost effectively distributing electronic content is provided. The system for cost effectively distributing electronic content may comprise an inquiry module that may query one or more broadcast communication networks for network specific information. The system may further comprise an analysis module that may determine a cost of distributing the electronic content to one or more electronic reader devices over one or more broadcast communication networks using at least the network specific information. The system may also comprise a selection module that may select the one or more broadcast communication networks for distributing the electronic content based on the cost. The system may additionally comprise a distribution module that may broadcast the electronic content for distribution to the one or more electronic reader devices over one or more selected broadcast communication networks.

### FIELD OF THE INVENTION

The present invention relates to content distribution, generally, and a system and method for cost effectively distributing electronic content, in particular.

### BRIEF DESCRIPTION OF THE DRAWINGS

The present invention, together with further objects and advantages, may best be understood by reference to the following description taken in conjunction with the accompanying drawings, in the several figures of which like reference numerals identify like elements, and in which:

FIG. 1 is a schematic diagram of a system for cost effectively distributing electronic content according to an embodiment of the present invention;

FIG. 2 is a flowchart of a method for cost effectively distributing electronic content according to an embodiment of the present invention; and

FIG. 3 is a flowchart of a method for cost effectively distributing electronic content according to an embodiment of the present invention.

### DETAILED DESCRIPTION OF EMBODIMENTS

Certain embodiments of the present invention provide a system and method for cost effectively distributing electronic content. Embodiments of a system and method for cost effectively distributing electronic content may be used to distribute electronic content, such as publications, periodical, newspapers, and the like, to one or more electronic reader devices in a cost efficient manner. Embodiments of a system and method for cost effectively distributing electronic content may be used to optimize cost by distributing the electronic content over one or more broadcast communication networks selected based on cost. Embodiments of a system and method for cost effectively distributing electronic content may be also used to enhance the distribution of electronic content by considering one or more factors in addition to cost, such as the bandwidth of one or more broadcast communication networks or the time of distribution of the electronic content and the like.

Traditional paper based publications are distributed by using traditional delivery mechanisms. Generally, paper based publications are created and shipped to a printing press which prints the paper based publication. The paper based publications are then placed on publication delivery vehicles. The publication delivery vehicles distribute the paper based publication for home or office delivery in the middle of the night or early in the morning. However, through advances in technology, electronic versions of paper based publications may now be distributed over communications networks to end-user devices, such as mobile devices. The end-user devices receive an electronic version of the paper based publication and a user of an end-user device can read the publication directly on the device. Generally, the cost of distributing the electronic versions of paper based publications are not taken into consideration. This may make it very expensive and inefficient to distribute electronic versions of paper based publications.

These and other challenges create a need for a system and method for cost effectively distributing electronic content. There is a need to improve the cost effectiveness and distribution of electronic content to electronic reader devices.

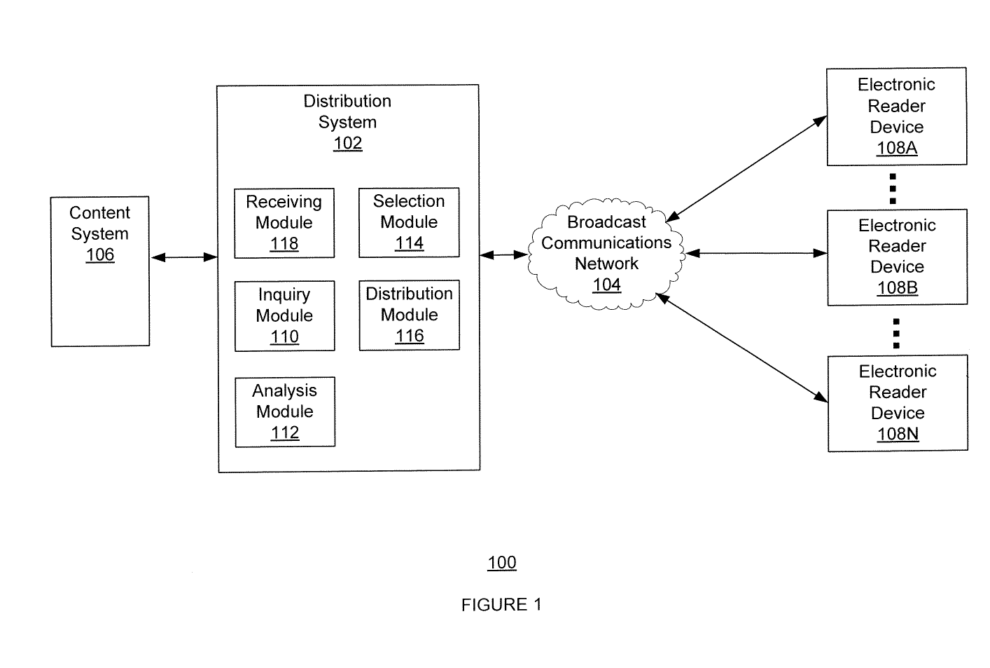

FIG. 1 is a schematic diagram of a system 100 for cost effectively distributing electronic content according to an embodiment of the present invention. The system 100 may include a distribution system 102, a broadcast communication network 104, a content system 106, and one or more electronic reader devices 108A, 108B, 108N.

The content system 106 may be coupled to the distribution system 102. The content system 106 may be used to generate electronic content. The content system 106 may include any, or a combination, of software and hardware configured to provide any, or a combination, of pre-production and production services. The pre-production and production services may be used to generate the electronic content. The functionalities of the content system 106 may include the functionalities of the content system described in U.S. patent application Ser. No. 12/563,328 entitled “Systems, Methods And Apparatus For Broadcast Content Distribution,” filed on Sep. 21, 2009, which is incorporated by reference herein in its entirety.

The electronic content may be publications, newspapers, periodicals, a magazine, books, electronic media information, electronic version of print media, advertisements and other information that can be distributed electronically. For example, electronic content may be an electronic version of a daily newspaper (i.e. electronic version of the Houston Chronicle newspaper). In another example, the electronic content may be an electronic version of a breaking news update. In another example, electronic content may be an electronic version of a monthly magazine (e.g., the electronic version of O, The Oprah Magazine). In another example, electronic content may be an electronic version of an advertisement or an advertising campaign for a particular product or service.

The distribution system 102 may receive the electronic content from the content system 106. The distribution system 102 may include any, or a combination, of software and hardware. The distribution system 102 may include a receiving module 118, an inquiry module 110, an analysis module 112, a selection module 114, and a distribution module 116. The distribution system 102 may be used to determine a cost of distributing electronic content to one or more electronic reader devices 108A, 108B, 108N. The distribution system 102 may also select one or more broadcast communication networks 104 based on the cost. The distribution system 102 may further distribute the electronic content to one or more electronic reader devices 108A, 108B, 108N over the selected one or more broadcast communication networks 104. The distribution system 102 may be capable of supporting both bi-directional and uni-directional communications. In some embodiments, the distribution system 102 may be capable of generating electronic content. In another embodiment, the distribution system 102 may include pre-loaded electronic content. The receiving module 118, inquiry module 110, analysis module 112, selection module 114, and distribution module 116 may perform the tasks of the distribution system 102.

The receiving module 118 may be capable to receiving electronic content. The receiving module 118 may receive the electronic content from the content system 106. The receiving module 118 may receive the electronic content over a communications network or via a data path. The receiving module 118 may include any, or a combination, of software and hardware. The receiving module 118 may be in communication with the inquiry module 110, analysis module 112, selection module 114, and distribution module 116. The receiving module 118 may transmit the electronic content to the inquiry module 110, analysis module 112, selection module 114, and distribution module 116.

The inquiry module 110 may be capable of querying one or more broadcast communication networks 104. The inquiry module 110 may query the one or more broadcast communication networks 104 for network specific information. For example, the inquiry module 110 may query a broadcast communication network 104 for a cost of distributing electronic content over the network between the hours of 4 am and 7 am. In another example, the inquiry module 110 may query a broadcast communication network 104 for the peak, intermediate, and non-peak times of distributing information over that particular network. The inquiry module 110 may receive network specific information from the one or more broadcast communication networks 104 in response to the query. The inquiry module 110 may query the one or more broadcast communication networks 104 by sending a signal to the one or more broadcast communication networks 104. The one or more broadcast communication networks 104 may respond by transmitting a reply signal that includes the network specific information. Network specific information may include the name of a broadcast communication network, a bandwidth of the network, a cost of distributing content over the network, the speed of the network, the status of the network, the IP address of the network, the security scheme of the network, the number of people connected to the network, the amount of data currently or generally being distributed over the network, a distribution schedule for the network, and other information related to a communications network.

In some embodiments, the inquiry module 110 may also be capable of probing the one or more broadcast communication networks 104 for network specific information. In some embodiments, the inquiry module 110 may gain access to the one or more broadcast communication networks 104 and acquire the network specific information. The inquiry module 110 may periodically query or probe the one or more broadcast communication networks 104 for network specific information. The inquiry module 110 may also query or probe for additional information related to the one or more broadcast communication networks 104. The network specific information may include any pertinent or relevant information regarding the one or more broadcast communication networks 104.

The inquiry module 110 may include any, or a combination, of software and hardware. The inquiry module 110 may be in communication with the receiving module 118, analysis module 112, selection module 114, and distribution module 116. The inquiry module may also transmit the network specific information to the analysis module 112, selection module 114, and distribution module 116.

The analysis module 112 may be capable of determining a cost of distributing electronic content over the one or more broadcast communication networks 104. The analysis module 112 may determine a cost of distributing the electronic content to one or more electronic reader devices 108A, 108B, 108N over one or more the broadcast communication networks 104. The analysis module 112 may determine the cost by using at least the network specific information. For example, the analysis module 112 may determine the cost of transmitting 10 Megabytes of electronic content over a broadcast communication network 104 that charges $X.XX per Megabyte of data. In another example, the analysis module 112 may determine the cost of transmitting 20 Megabytes of electronic content over a broadcast communication network 104 that charges different rates for distributing content during peak, intermediate and non-peak times.

The analysis module 112 may analyze or dissect at least the network specific information to determine the cost of distributing the electronic content. The analysis module 112 may also use additional information to determine the cost of distributing the electronic content. The additional information may include the location of the reader devices 108A, 108B, 108B, the proximity of the reader devices 108A, 108B, 108N to the one or more broadcast communication networks 104, the broadcast history of the reader devices 108A, 108B, 108N, and any other factor that may be used to determine a cost of distributing data. The analysis module 112 may use computing or software algorithms to determine the cost of distributing electronic content over the one or more broadcast communication networks 104. The cost of distributing the electronic content may be determined based on any information received from the one or more broadcast communication networks 104. In some embodiments, the cost of distributing the electronic content may be based on the time of distribution of the electronic content.

The selection module 114 may be capable of processing data. The selection module 114 may be a hardware, software component or the like. The selection module 114 may be coupled to the distribution system 102 or may be remote or external from the distribution system 102. The selection module 114 may receive the cost of distributing electronic content over the one or more broadcast communication networks 104 from the analysis module 112. The selection module 114 may be capable of selecting the one or more broadcast communication networks 104 for distributing the electronic content based on the cost. The selection module 114 may be used to compare the cost of distributing electronic content over the one or more broadcast communication networks 104. For example, the selection module 114 may compare a cost of distributing an electronic edition of a print subscription over Network X vs. Network Y. The selection module 114 may use software or computing algorithms to compare the cost of distributing the electronic content over the one or more broadcast communication networks 104. The selection module 114 may select the one or more broadcast communication networks 104 based on cost.

In some embodiments, the selection module 114 may select the one or more broadcast communication networks 104 based on one or more additional factors. Additional factors may include a schedule for distributing electronic content, time of distribution of the electronic content, the reliability of the broadcast communication network, historical performance of the network, speed of the network, capacity of the network, preferences of the user of the one or more electronic reader devices, preferences of the distribution system, network specific information, and any other additional information.

The distribution module 116 may be a hardware, software component or the like. The distribution module 116 may be coupled to the distribution system 102 or may be remote or external from the distribution system 102. The distribution module 116 may transmit the electronic content to one or more selected broadcast communication networks 104. The distribution module 116 may be capable of broadcasting the electronic content to one or more electronic reader devices 108A, 108B, 108N by using one or more selected broadcast communication networks 104. The distribution module 116 may transmit the electronic content to the broadcast communication network 104 for broadcast transmission to one or more electronic reader devices 108A, 108B, 108N. The distribution module 116 may encrypt or encode the electronic content prior to transmitting the content to the one or more selected broadcast communication networks 104. The distribution module 116 may be in communication with the receiving module 118, inquiry module 110, analysis module 112, and selection module 114. The distribution module 116 may receive info nation related to the one or more selected broadcast communication modules from the selection module 114.

The distribution module 116 may schedule the electronic content to be distributed to the one or more reader devices 108A, 108B, 108N. The distribution of periodical content (i.e. subscriptions) according to a distribution schedule may result in a predicable volume of network traffic over a particular network at a specific time. This may be useful in determining the core times for network traffic and optimizing times to distribute electronic content. The distribution module 116 may generate or determine a distribution schedule prior to broadcasting the electronic content to the one or more reader devices 108A, 108B, 108N. The distribution module 116 may generate or determine a distribution schedule that indicates one or more scheduled times at which to distribute the electronic content. The distribution module 116 may generate or determine a distribution schedule to optimize network bandwidth consumption for distribution and providing guaranteed on-time electronic content delivery services (e.g., timely distribution). For example, timely distribution of electronic content to may include distribution every morning, every evening, at 7:00 AM, 7:00 PM, or any other selected time interval or time.

In some embodiments, the distribution module 116 may broadcast the electronic content in accordance with the distribution schedule. For example, the distribution module 116 may broadcast the electronic content (i.e. daily newspaper such as the Houston Chronicle) every morning at 2:00 AM (e.g., at a time prior to the availability or delivery of the hard copy version of the Houston Chronicle news paper, at a time that is the same as the availability or delivery of the hard copy version of the Houston Chronicle news paper). In another example, the distribution module 116 may broadcast the electronic content (e.g., a monthly magazine such as O, The Oprah Magazine) on the first of every month at 4:00 AM (e.g., at a time prior to the availability or delivery of the hard copy version of O, The Oprah Magazine, at a time that is the same as the availability or delivery of the hard copy version of O, The Oprah Magazine). In another example, the distribution module 116 may broadcast electronic content (e.g., an advertisement such as ad for Cosmopolitan magazine) on Monday of every week at 6:00 AM. In yet another example, the distribution module 116 may broadcast the electronic content (e.g., an up-to-date breaking news source such as a News Services breaking news) immediately (e.g., as soon as practicable to ensure delivery of electronic content that is not stale).

In some embodiments, the distribution module 116 may broadcast the electronic content according to the time zone and/or local geography of the one or more electronic reader devices 108A, 108B, 108N. The time zone and/or local geography of the one or more electronic reader devices 108A, 108B, 108N may affect when the electronic content is distributed to the one or more electronic reader devices 108A, 108B, 108N. For example, electronic content generated at a specific time (e.g., generating a daily newspaper such as the New York Times at 2:00 AM EST) may be distributed to one or more electronic reader devices 108A, 108B, 108N located in the eastern time zone (i.e. New York) before being distributed to one or more electronic reader devices 108A, 108B, 108N located in the pacific time zone (i.e. San Francisco). Factors such as the optimal time to deliver the electronic content or cost may affect whether the time zone and/or geographical location impact the delivery of electronic content to the one or more reader devices 108A, 108B, 108N.

The one or more broadcast communication networks 104 may include any, or a combination, of software and hardware configured to receive the electronic content from the distribution system 102. In various embodiments, the one or more broadcast communication networks 104 may include any, or a combination, of software and hardware configured to broadcast the electronic content to the one or more electronic reader devices 108A, 108B, 108N. The one or more broadcast communication networks 104 may also support bi-directional and uni-directional communication. The one or more broadcast communication networks 104 may encrypt or encode the electronic content prior to broadcast. The one or more broadcast communication networks 104 may broadcast the electronic content via a communications network, wired communications network, wireless communications network, data path or broadcast channel. For example, the one or more broadcast communication networks 104 may include any, or a combination, of one or more FM radio transmission towers, one or more television transmission towers, one or more wireless communication networks, one or more Wi-Fi networks, one or more ATSC networks, one or more 3G or 4G networks, one or more GSM networks, and one or more satellite radio networks configured to broadcast the electronic content to the reader devices 108A, 108B, 108N.

The one or more electronic reader devices 108A, 108B 108N may include any, or a combination, of software and hardware. The electronic reader devices 108A, 108B, 108N may be capable of receiving the electronic content. The electronic reader devices 108A, 108B, 108N may be capable of tuning in or waiting to receive the electronic content. The electronic reader devices 108A, 108B, 108N may receive the electronic content over the one or more broadcast communication networks 104. The electronic reader devices 108A, 108B, 108N may receive the electronic content over a communications network coupled to the one or more broadcast communication networks 104. In various embodiments, the reader devices 108A, 108B, 108N may be configured to receive the electronic content at one or more scheduled times (e.g., approximate scheduled times).

In various embodiments, the one or more electronic reader devices 108A, 108B, 108N may be configured to display the electronic content to the end-user (e.g., subscriber) using a display (e.g., a display screen, a plasma screen, a Liquid Crystal Display (LCD) device). In some embodiments, the display may be an electrophoretic displays or electro-wetting displays. Examples of such displays include those disclosed in U.S. Pat. Nos. 6,577,433, 6,529,313, 6,525,866, 6,574,034, 6,017,584, 6,067,185, 6,118,426, 6,120,839, 6,124,851, 6,130,774, 6,172,798, 6,177,921, 6,232,950 and 6,249,271. An exemplary such electronic panel display and is disclosed in U.S. patent application Ser. No. 12/497,199 entitled “Electronic Display Controller,” filed Jul. 2, 2009, the contents of which are hereby incorporated by reference.

The functionalities of the electronic reader devices 108A, 108B, 108N may include those described in U.S. patent application Ser. No. 12/563,328 entitled “Systems, Methods And Apparatus For Broadcast Content Distribution,” filed on Sep. 21, 2009, which is incorporated by reference herein in its entirety.

The one or more reader devices 108A, 108B, 108N may maintain power in order to receive the electronic content. The one or more reader devices 108A, 108B, 108N may remain in a low power mode or only maintain enough power to keep on a receiver in order to receive the electronic content. The one or more reader devices 108A, 108B, 108N may tune in or listen to the one or more communication networks 104 to detect when to receive the electronic content. When the electronic content is detected, the one or more reader devices 108A, 108B, 108N may power up or initiate the power up of the remaining portions of the one or more reader devices 108A, 108B, 108N in anticipation of the broadcast electronic content. In various embodiments, the entire one or more reader devices 108A, 108B, 108N or a portion of the one or more reader devices 108A, 108B, 108N may be powered up in anticipation of the broadcast electronic content necessary to receive and store the electronic content.

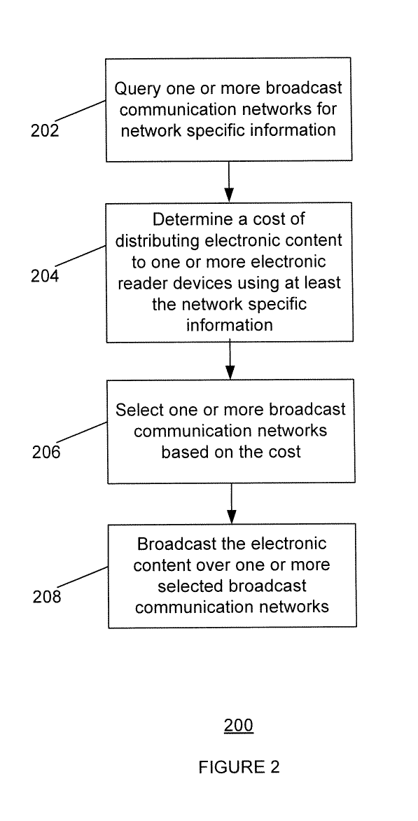

FIG. 2 illustrates a flowchart of a method for cost effectively distributing electronic content according to an embodiment of the present invention. At block 202, one or more broadcast communication networks 104 are queried for network specific information. The inquiry module 110 may query the one or more broadcast communication networks 104 for network specific information. In some embodiments, the inquiry module 110 may also probe the one or more broadcast communication networks 104 for network specific information. At block 204, a cost of distributing the electronic content to one or more electronic reader devices 108A, 108B, 108N over one or more broadcast communication networks 104 may be determined. The analysis module 112 may determine the cost of distributing the electronic content. The analysis module 112 may use at least the network specific information to determine the cost of distributing the electronic content. The analysis module 112 may use computing or software algorithms to determine the cost of distributing the electronic content.

At block 206, one or more broadcast communication networks 104 for distributing the electronic content are selected based on the cost. The selection module 114 may be used to select the one or more broadcast communication networks 104. The selection module 114 may select the one or more broadcast communication networks 104 based on one or more additional factors. The selection module 114 may use computing or software algorithms to select the one or more broadcast communication networks 104. At block 208, the electronic content for distribution to the one or more electronic reader devices 108A, 108B, 108N may be broadcasted over one or more selected broadcast communication networks 104. The distribution module 116 may broadcast the electronic content for distribution to the one or more electronic reader devices 108A, 108B, 108N over one or more selected broadcast communication networks 104. The distribution module 116 may determine a distribution schedule prior to broadcasting the electronic content to the one or more reader devices 108A, 108B, 108N. A distribution schedule may indicate one or more scheduled times at which the electronic content is to be distributed.

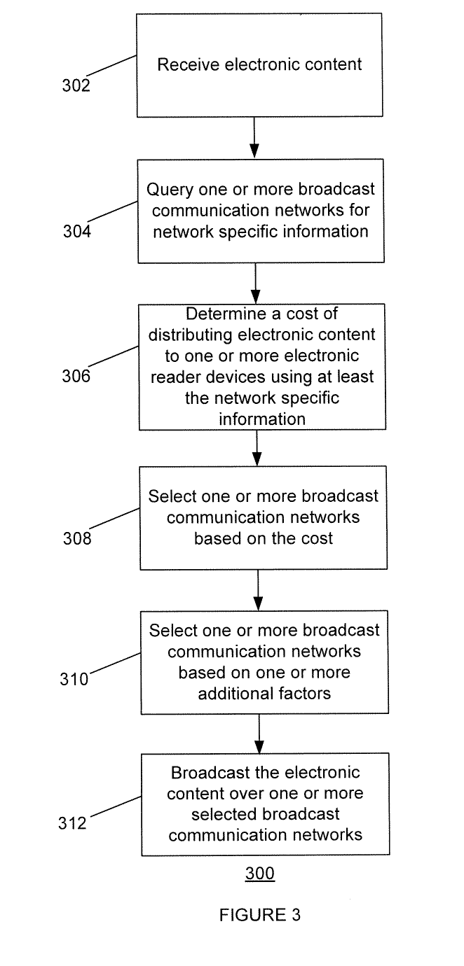

FIG. 3 illustrates a flowchart of a method for cost effectively distributing electronic content according to an embodiment of the present invention. At block 302, electronic content may be received. The electronic content may be received from the content system 106. The receiving module 118 may receive the electronic content. At block 304, one or more broadcast communication networks are queried for network specific information. The inquiry module 110 may query the one or more broadcast communication networks 104 for network specific information. In some embodiments, the inquiry module 110 may also probe the one or more broadcast communication networks 104 for network specific information. At block 306, a cost of distributing the electronic content to one or more electronic reader devices 108A, 108B, 108N over one or more broadcast communication networks 104 may be determined. The analysis module 112 may determine the cost of distributing the electronic content using network specific information. The analysis module 112 may use computing or software algorithms to determine the cost of distributing the electronic content.

At block 308, one or more broadcast communication networks 104 for distributing the electronic content are selected based on the cost. The selection module 114 may be used to select the one or more broadcast communication networks 104. At block 310, one or more broadcast communication networks 104 for distributing electronic content are selected based on one or more additional factors. Additional factors may include a schedule for distributing electronic content, time of distribution of the electronic content, the reliability of the broadcast communication network, historical performance of the network, speed of the network, capacity of the network, preferences of the user of the one or more electronic reader devices, preferences of the distribution system, network specific information, and any other additional information. The selection module 114 may use computing or software algorithms to select the one or more broadcast communication networks 104.

At block 312, the electronic content for distribution to the one or more electronic reader devices 108A, 108B, 108N may be broadcasted over one or more selected broadcast communication networks 104. The distribution module 116 may broadcast the electronic content for distribution to the one or more electronic reader devices 108A, 108B, 108N over one or more selected broadcast communication networks 104.

The description above describes systems, networks, and reader devices, that may include one or more modules, some of which are explicitly shown in the figures. As used herein, the term “module” may be understood to refer to any, or a combination, of computing software, firmware, and hardware. It is noted that the modules are exemplary. The modules may be combined, integrated, separated, or duplicated to support various applications. Also, a function described herein as being performed at a particular module may be performed at one or more other modules or by one or more other devices instead of or in addition to the function performed at the particular module. Further, the modules may be implemented across multiple devices or other components local or remote to one another. Additionally, the modules may be moved from one device and added to another device, or may be included in multiple devices.

It is further noted that the software described herein may be tangibly embodied in one or more physical media, such as, but not limited to any, or a combination, of a compact disc (CD), a digital versatile disc (DVD), a floppy disk, a hard drive, read only memory (ROM), random access memory (RAM), and other physical media capable of storing software. Moreover, the figures illustrate various components (e.g., systems, networks, and reader devices) separately. The functions described as being performed at various components may be performed at other components, and the various components may be combined or separated. Other modifications also may be made.

In the instant specification, various exemplary embodiments have been described with reference to the accompanying drawings. It will, however, be evident that various modifications or changes may be made thereto, or additional embodiments may be implemented, without departing from the broader scope of the invention as set forth in the claims that follow. The specification and drawings are accordingly to be regarded in an illustrative rather than a restrictive sense.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from its spirit or essential attributes.

We claim:

1. A computer-implemented method for cost effectively distributing electronic content, the computer-implemented method co sing:
querying one or more broadcast communication networks for network specific information;
determining a cost of distributing electronic content to one or more electronic reader devices over one or more broadcast communication networks using at least the network specific information;
selecting the one or more broadcast communication networks for distributing the electronic content based on the cost; and
broadcasting the electronic content for distribution to the one or more electronic reader devices over one or more selected broadcast communication networks.

2. The computer-implemented method of claim 1, further comprising:
receiving electronic content from a content system.

3. The computer-implemented method of claim 1, further comprising:
selecting the one or more broadcast communication networks for distributing the electronic content based on one or more additional factors.

4. The computer-implemented method of claim 3, wherein the one or more additional factors comprise time of distribution of the electronic content, the reliability of the broadcast communication network, preferences of the user of the one or more electronic reader devices and the network specific information.

5. The computer-implemented method of claim 1, wherein the one or more broadcast communication networks are periodically queried for network specific information.

6. The computer-implemented method of claim 1, wherein the one or more electronic reader devices are configured to employ one or more power management techniques.

7. The computer-implemented method of claim 1, wherein the electronic content is periodical content.

8. The computer-implemented method of claim 1, wherein the one or more broadcast communication networks comprise one or more wireless communication networks.

9. The computer-implemented method of claim 1, wherein the one or more broadcast communication networks comprise one or more Frequency Modulation (FM) radio transmission towers.

10. The computer-implemented method of claim 1, wherein the one or more broadcast communication networks comprise one or more television towers.

11. The computer-implemented method of claim 1, further comprising:
determining one or more scheduled times to distribute electronic content to the one or more reader devices.

12. A computer-implemented method for cost effectively distributing electronic content, the computer-implemented method comprising:
receiving electronic content from a content system;
querying one or more broadcast communication networks for network specific information;
determining a cost of distributing the electronic content to one or more electronic reader devices over one or more broadcast communication networks using at least the network specific information;
selecting the one or more broadcast communication networks for distributing the electronic content based on the cost;
selecting the one or more broadcast communication networks for distributing the electronic content based on one or more additional factors; and
broadcasting the electronic content for distribution to the one or more electronic reader devices over one or more selected broadcast communication networks.

13. A computer-implemented method of claim 12, further comprising:
determining one or more scheduled times to distribute electronic content to the one or more reader devices;

14. A computer-implemented method of claim 13, wherein the one or more additional factors comprise time of distribution of the electronic content, the reliability of the broadcast communication network, preferences of a distribution system, preferences of the user of the one or more electronic reader devices and the network specific information.

15. A computer-implemented method of claim 12, wherein the one or more broadcast communication networks are periodically queried for network specific information.

16. A computer-implemented method of claim 12, wherein the electronic content is periodical content.

17. A computer-implemented system for cost effectively distributing electronic content, the computer-implemented method comprising:
an inquiry module configured to query one or more broadcast communication networks for network specific information;
an analysis module configured to determine a cost of distributing the electronic content to one or more electronic reader devices over one or more broadcast communication networks using at least the network specific information;
a selection module configured to select the one or more broadcast communication networks for distributing the electronic content based on the cost; and
a distribution module configured to broadcast the electronic content for distribution to the one or more electronic reader devices over one or more selected broadcast communication networks.

18. A computer-implemented system of claim 17, wherein the electronic content is periodical content.

19. The computer-implemented system of claim 17, further comprising:
a receiving module configured to receive electronic content from a content system;

20. The computer-implemented system of claim 17, wherein the selection module is further configured to select the one or more broadcast communication networks for distributing the electronic content based on one or more additional factors.

21. The computer-implemented system of claim 17, wherein the inquiry module is further configured to periodically query the one or more broadcast communication networks for network specific information.

22. The computer-implemented system of claim 17, wherein the distribution module is further configured to determine one or more scheduled times to distribute electronic content to the one or more reader devices.
